(19) United States
(12) Patent Application Publication
(10) Pub. No.: US 2020/0379983 A1
(43) Pub. Date: Dec. 3, 2020

(54) STRUCTURED QUERY FACILITATION APPARATUS AND METHOD

(71) Applicant: Walmart Apollo, LLC, Bentonville, AR (US)

(72) Inventors: Rocky S. Green, Rogers, AR (US); Timothy A. Baker, Bella Vista, AR (US); Vasantha Kumar Kaminahal Matam, Bentonville, AR (US); Gnana Bharath C. Nedurumalli, Rogers, AR (US)

(21) Appl. No.: 16/889,553

(22) Filed: Jun. 1, 2020

Related U.S. Application Data
(60) Provisional application No. 62/855,769, filed on May 31, 2019.

(51) Int. Cl. G06F 16/23; G06F 16/28; G06F 16/953

(52) U.S. Cl. CPC G06F 16/2379; G06F 16/953; G06F 16/284

(57) ABSTRACT

A control circuit receives from a message source via a network interface a database-update message having at least one data object in a data-independent data format comprising human-readable text. The control circuit then automatically converts that data object into a structured query language (SQL) message. Upon then selecting at least one of a plurality of candidate SQL databases to provide a selected SQL database, the control circuit transmits the SQL message to the selected SQL database.

### CROSS-REFERENCE TO RELATED APPLICATION

This application claims the benefit of U.S. Provisional Application No. 62/855,769 filed May 31, 2019, which is incorporated herein by reference in its entirety.

### TECHNICAL FIELD

These teachings relate generally to structured queries and more particularly to structured query language databases.

### BACKGROUND

Relational databases are known in the art. Relational databases typically consist of structured data content and hence constitute relational data with relationships between data items being stored and revealed by tables consisting, for example, of rows and columns. Relational databases follow precise and complex entry/storage requirements in order to ensure that the intended relationships are unambiguously stored. Consequently, relational database queries follow similarly precise and complex query syntax/content requirements in order to ensure an accurate search of the database.

Structured query language (SQL) is a special-purpose programming language designed for managing data held in a relational database management system. Originally based upon relational algebra and tuple relational calculus, SQL consists of a data definition language and a data manipulation language. The scope of SQL includes data insert, query, update and delete, schema creation and modification, and data access control.

Unfortunately, though certainly powerful, SQL is not necessarily user-friendly or intuitive. As a result, it can be frustrating or even impossible (from a practical standpoint) for many users in, for example, a large multi-store retail enterprise setting to effectively update or otherwise leverage the contents of a relational database to accomplish any number of routine inquiries that such users might ordinarily seek to conduct during the course of a typical workday. Having an SQL expert continually available is typically not a viable solution in such application settings nor is training all potential users to be proficient in SQL.

The foregoing concerns are further heightened when there are a plurality of SQL-based databases available and in play in a given application setting.

### BRIEF DESCRIPTION OF THE DRAWINGS

The above needs are at least partially met through provision of the structured query facilitation apparatus and method described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a communication protocol timing diagram as configured in accordance with various embodiments of these teachings; and

FIG. 4 comprises a comparative schematic representation as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, pursuant to these various embodiments a control circuit receives from a message source via a network interface a database-update message having at least one data object in a data-independent data format comprising human-readable text. The control circuit then automatically converts that data object into a structured query language (SQL) message. Upon then selecting at least one of a plurality of candidate SQL databases to provide a selected SQL database, the control circuit transmits the SQL message to the selected SQL database.

These teachings will accommodate various approaches in the foregoing regards. As one example, and by one approach, the control circuit comprises a Web server that runs in an Apache Tomcat instance.

By one approach, the aforementioned data-independent data format comprises a JavaScript Object Notation (JSON) format.

By one approach the aforementioned human-readable text includes information specifying such things as a particular country, a particular store, and a particular date. The aforementioned data-independent data format can support one or more value types such as, but not limited to, stringValue, intValue, doubleValue, boolValue, and dateValue.

By one approach, and subsequent to transmitting the SQL message as described above, the control circuit can be further configured to transmit to the message source and via the network interface a follow-up message comprising human-readable text. The latter can convey information such as a successful interaction with the selected SQL database or an error message as provided by the latter.

So configured, such a system can facilitate real-time or near real-time data transport. In many application settings the described transmissions and updating activities can also take place with far more reliability than with many previous approaches, at least in part because there are fewer points of failure. In addition, such a configuration can act as a kind of buffer that helps to protect the database(s) from too many attempted inputs at any given time. In addition, devices sending such data can benefit greatly from not themselves having to establish database connections or to securely store credentials that are otherwise required to access the database(s).

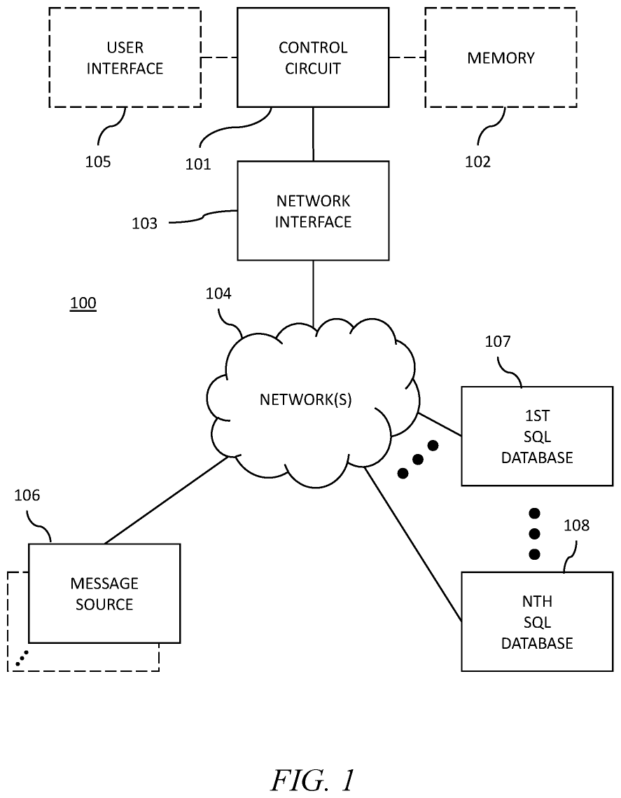

These and other benefits may become clearer upon making a thorough review and study of the following detailed description. Referring now to the drawings, and in particular to FIG. 1, an illustrative apparatus 100 that is compatible with many of these teachings will be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to information that identifies available SQL databases, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

In this example the control circuit 101 operably couples to a network interface 103. Numerous examples are known in the art. A non-exhaustive listing would include Universal Serial Bus (USB)-based interfaces, RS232-based interfaces, I.E.E.E. 1394 (aka Firewire)-based interfaces, Ethernet-based interfaces, any of a variety of so-called Wi-Fi™-based wireless interfaces, Bluetooth™-based wireless interfaces, cellular telephony-based wireless interfaces, Near Field Communications (NFC)-based wireless interfaces, standard telephone landline-based interfaces, cable modem-based interfaces, and digital subscriber line (DSL)-based interfaces. Such interfaces can be selectively employed to communicatively couple the apparatus 100 to another control circuit and/or to any of a variety of networks 104 including local area networks and/or one or more wide area networks or extranets (such as, but not limited to, the Internet).

So configured the control circuit 101 can communicate with other elements (both within the apparatus 100 and external thereto) via the network interface 103. As will be described in more detail below, these other elements can include, but are not limited to, one or more message sources 106 and any of a plurality of available SQL databases 107, 108. The present teachings are not especially sensitive to what platform might serve as a message source 106, and examples readily include but are not limited to desktop computers, rack-mounted computers, laptop computers, so-called smartphones and tablet/pad-styled computers, cloud-based computers, and so forth.

The SQL databases 107, 108 may all be operated by and/or for the benefit of a single enterprise but may themselves each constitute a physically and logically separate database. Any one of these databases may contain information unique to that database or that is also shared in common with one or more of the other databases.

By one optional approach (in lieu of the foregoing or in combination therewith) the control circuit 101 operably couples to a user interface 105. This user interface 105 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

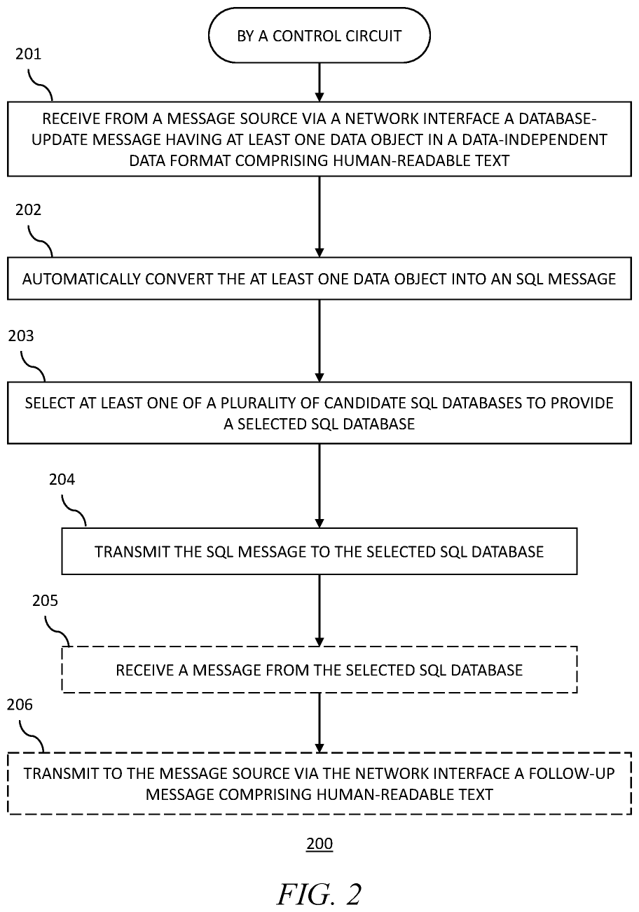

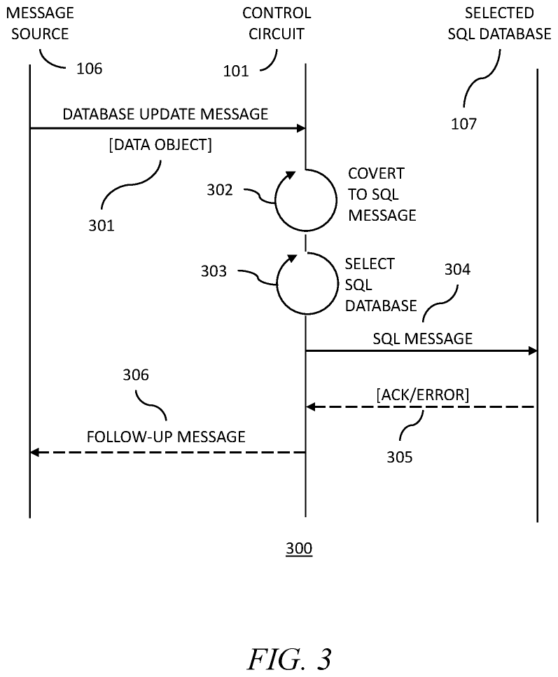

Referring now to FIGS. 2 and 3 and with continuing reference to FIG. 1, a process 200 can be carried out via the above-described apparatus 100 and in particular by the above-described control circuit 101.

At block 201, the control circuit 101 receives from a message source 106 (via the above-described network interface 103) a database-update message 301 having at least one data object in a data-independent data format comprising human-readable text. (Data-independence as used here means that the service is not coupled in any way to the data itself, to specific tables, or to data elements. Accordingly, data-independent refers to an agnostic approach that can be used for any data and every potential use case. Accordingly, data-independent will be understood to not refer to a normal tightly-coupled data-dependent web service where, for example, changing the name of a data element can disrupt the operability of the service because the data element with the altered name probably does not exist. Instead, data-independent presumes only loose coupling at most with no tie to specific data elements or specific names.) This database-update message 301 may be conveyed in any of a variety of ways including, but not limited to, a browser-based communication, email, text messaging, or an app-based communication.

By one approach the data-independent data format comprises a JavaScript Object Notation (JSON) format. JSON is a language-independent data format and is an open-standard file format that uses human-readable text to transmit data objects consisting of attribute-value pairs and array data types (or any other serializable value). JSON can serve well to support asynchronous browser-server communications.

By one approach the aforementioned human-readable text includes information specifying such things as a particular country, a particular store, and a particular date. The aforementioned data-independent data format can support one or more value types such as, but not limited to, stringValue, intValue, doubleValue, boolValue, and dateValue. By one approach, if desired, the aforementioned data-independent data format only supports insert, update, and select value types.

In this example the database-update message 301 includes content to be provided to one or more of a plurality of SQL databases. That said, the contents of the database-update message 301, and in particular the aforementioned data object, are not in a suitable syntax and/or format to effect such usage. In particular, that information is not in the form of a structured query language instruction.

At block 202, the control circuit 101 automatically converts the at least one data object into a corresponding SQL message (see reference numeral 302 in FIG. 3 as well). In particular, the resultant SQL message contains the upload payload content of the aforementioned database-update message 301. Now, however, the latter content is compatibly presented in an appropriate SQL-compatible instruction.

By one approach the control circuit 101 processes the non-SQL content by separating the keys from non-key columns or fields. An SQL filter or match condition can be built that uses the key columns but which first determines which ones of those are a requirement satisfied by the data structure itself. Based on the keys and columns, three different combinations are possible: keys only, columns only, or both. In addition to this, values can either be excluded or included, and there are several options for delimiting multi-record datasets (an equals sign, a comma, or the conjunction “AND”). Also, values can either be inserted directly into the SQL, or dynamically injected to the database using a prepared statement, for security and batch processing reasons. This requires placeholders to be put there first by the control circuit 101 serving as an SQL processor. This yields 24 different combinations, though not all of them are useful. From these combinations, many different SQL clauses can be assembled. The SQL processor accordingly understands how to build the following types of SQL clauses: key, update, insert, select, fields, join, single key, and merge, each of which may be required in a specific circumstance.

At block 203 (see also reference numeral 303 of FIG. 3), the control circuit selects at least one of a plurality of candidate SQL databases 107, 108 to provide a selected SQL database. For the sake of an illustrative example it will be presumed here that the first SQL database 107 is the selected SQL database. A particular one or more of the candidate SQL databases can be selected using any desired criteria. By one approach the selection can be automatically based upon categorical information contained in the database-update message 301. The latter approach can be particularly helpful when the database-update message 301 does not itself explicitly identify any particular destination SQL database. By one approach the destination database can be selected by the client sending the message (the host name of the database is required).

Having selected a particular SQL database, at block 204 the control circuit 101 transmits the aforementioned SQL message 304 to the selected SQL database 107. By one approach the control circuit 101 accesses stored connection credentials for each specific database system to facilitate this transmission. This transmission can be facilitated, for example, via the aforementioned network interface 103. Such a transmission can occur as soon as possible and where the transmission includes only this one SQL message. By another approach, if desired, many such messages can be aggregated over time and transmitted as a group in order to facilitate a batch-processing approach.

The destination SQL database can then process the update content to thereby update the contents of the SQL database itself. As appropriate, this activity can constitute deleting one or more database entries, adding one or more new database entries, or changing one or more existing database entries. Operating an SQL database constitutes a well-known area of prior art endeavor and requires no further description here.

By one approach the selected SQL database 107 will reply 305 to the control circuit 101 to acknowledge receipt of the SQL message 304 and/or to indicate some error either in transmission or in the original content/message. To the extent that this occurs, at block 205 the control circuit 101 can receive this message and then, at optional block 206, transmit to the message source 106 via the network interface 103 a follow-up message 306 comprising human-readable text to convey such things as a successful interaction with the selected SQL database 107 or an error message as appropriate.

Further details will now be provided regarding these teachings, including both further elaboration regarding activities described above as well as supplemental activities that may be utilized in a given application setting. It shall be understood that these details are provided to serve an illustrative purpose and are not intended to suggest any specific limitations with respect to these teachings.

By one approach the messages from the message source can have one of three or four different primary formats. Examples include a single insert format, a single update format, a multiple dataset format, and a select format (used for querying).

The single insert type of request can serve to insert one new row of data into the database. In this example the format differs from the single update format only in that key columns and non-key columns can be provided in the same list and do not need to be distinguished from one another.

The single update request type inserts or updates a new row of data into the database. The request format in this case requires the key columns and the non-key columns to be provided in two separate lists: a where list (for the keys) and a data list (for the others).

The multiple datasets request type can include multiple rows of data. Each row inside a dataset follows the same format as the single insert or single update. The control circuit 101 processes these sequentially, though it may batch them together to save processing time.

As described above the data-independent data format can comprise a JSON format. TABLE 1 presents an illustrative example of a JSON message format in these regards.

TABLE 1
{“requests”:

[{“id”:0,

“server”: “azrsqlcluteldev.cloud.CompanyName.com”,
“database”: “CT_MISC”,
“table”: “Web_Service_Sample”,
“type”: “insert”,
“data”: [

| | |
|---|---|
| {“id”:0, “field”:“countryCode”, | “stringValue”: “US”}, |

| | |
|---|---|
| {“id”:1, “field”:“storeNbr”, | “intValue”: 9947}, |

| | |
|---|---|
| {“id”:2, “field”:“report_date”, | “dateValue”: “2016-09- |

09T15:45:00.000”},

| | | |
|---|---|---|
| {“id”:3, “field”:“value”, | “doubleValue”: 17.76} | ] |

},
{“id”:1,
“server”: “azrsqlcluteldev.cloud.wal-mart.com”,
“database”: “CT_MISC”,
“table”: “Web_Service_Sample”,
“type”: “update”,
“data”: [

| | |
|---|---|
| {“id”:0, “field”:“report_date”, | “dateValue”: “2016-09- |

08T15:45:00.000”},

| | |
|---|---|
| {“id”:1, “field”:“value”, | “doubleValue”: 17.87} |

],
“where”: [

| | |
|---|---|
| {“id”:0, “field”:“countryCode”, | “stringValue”: “US”}, |
| {“id”:1, “field”:“storeNbr”, | “intValue”: 9947} |

]

}]

}

One can copy the above request into a tool like POSTMAN or CURL and send it to a corresponding web service.

By one approach, the optional follow-up message 306 sent from the control circuit 101 to the message source 106 can also employ a JSON format. TABLE 2 presents an illustrative example in these regards.

TABLE 2

{

″responses″: [

{

″response″: ″SUCCESS″,
″id”: 0,

}

]

}

As regards TABLE 2, the ID is simply a field to differentiate multiple JSON objects. Typically, one can only receive a single response object for each series of requests that are sent. The “response” field in this example will either constitute the word “SUCCESS” or an error message returned by the database and/or the web service. The “id” field indicates which of the requests (if there are multiple requests) the response indicator matches.

By one approach these teachings will accommodate subqueries. In particular, data elements can be specified through subqueries using the format shown in TABLE 3.

TABLE 3
{

“type”: “insert”,
“server”: “azrsqlcluteldev.cloud.wal-mart.com”,
“database”:“ SAM_EstateToolSet”,
“table”: “zap_send_info”,
“data”:[

{“id”:0, “field”:“store_id”, “query”:{

“select”:“store_id”,
“from”:“store dimension”,
“where”:[

{“id”:0, “field”:“store_number”, “intValue”:100},
{“id”:1, “field”:“country_code”, “stringValue”:“US”}

],
“result” :“intValue”

}

},
{“id”:1, “field”:“reply”, “stringValue”:“THISZAP_OK”},
{“id”:2, “field”:“apply_time”, “dateValue”:“2016-03-31 04:03:00AM”}

]

}

Using the foregoing the specified subquery will be processed first and the value returned from the subquery will then be used in the main query for store_id. The result field inside the query indicates the data type of the subquery result.

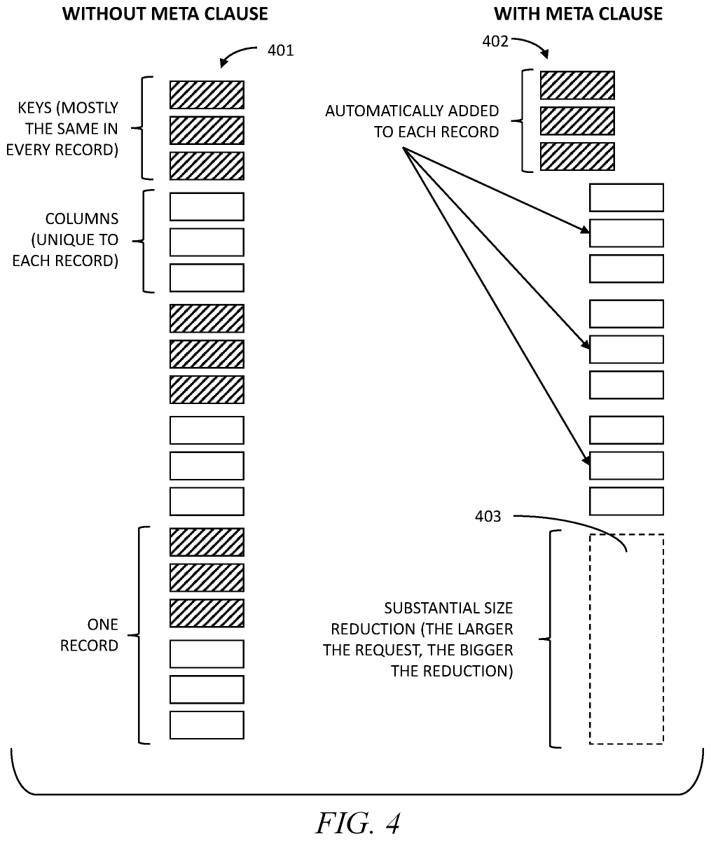

By one approach, and referring now to FIG. 4, these teachings will accommodate using a meta-clause feature to aid the message sources 106 to send compact messages. Rather than having to create multiple instances of the same data for the entity (such as a retail store or other facility) the message source 106 is sending from (for example, store 100, register 2, over and over again), such content can be included in a special meta clause. The control circuit 101 then performs the additional work of copying this data into each dataset in the entire request. FIG. 4 presents a comparative example in these regards, where a sample schematic representation of a message source transmission without such a meta clause appears on the left (as denoted by reference numeral 401) and a schematic representation of a message source transmission using such a meta clause appears on the right (as denoted by reference numeral 402). A schematic representation of the resultant size reduction of the transmission payload is denoted by reference numeral 403. An illustrative example of a data format that employs a meta clause appears below in TABLE 4.

TABLE 4
{″records″:[{″value″:
{″requests″: [

{

″metaWhere″: [

{″field″: ″StoreNbr″,″intValue″: ″9999″,″id″: 0},
{″field″: ″CountryCode″,″id″: 1,″stringValue″: ″US″}

],
″datasets″: [

{″data″: [

{″field″: ″StoreStatus″,″id″: 0,″stringValue″: ″OPEN″},

{″field″: ″OpenTime″,″id″: 1,″stringValue″: ″09:00:00″},
{″field″: ″CloseTime″,″id″: 2,″stringValue″: ″19:00:00″},
{″field″: ″EventTs″,″id″: 3,″dateValue″: ″2018-02-26 16:53:00″},
{″field″: ″ChangeId″,″id″: 4,″stringValue″: ″postest″}

],

“where”: [ ]
},
{ ... }

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A method comprising:
by a control circuit:
receiving from a message source via a network interface a database-update message having at least one data object in a data-independent data format comprising human-readable text;
automatically converting the at least one data object into a structured query language (SQL) message;
selecting at least one of a plurality of candidate SQL databases to provide a selected SQL database; and
transmitting the SQL message to the selected SQL database.

2. The method of claim 1 wherein the data-independent data format comprises a JavaScript Object Notation (JSON) format.

3. The method of claim 1 wherein the control circuit comprises a web server.

4. The method of claim 1 wherein the control circuit runs in an Apache Tomcat instance.

5. The method of claim 1 wherein the human-readable text includes information specifying a particular country, a particular store, and a particular date.

6. The method of claim 1 wherein the data-independent data format supports at least one of the following value types: stringValue, intValue, doubleValue, boolValue, and dateValue.

7. The method of claim 1 wherein the data-independent data format only supports insert, update, and select value types.

8. The method of claim 1 further comprising:
subsequent to transmitting the SQL message, transmitting to the message source via the network interface a follow-up message comprising human-readable text.

9. The method of claim 8 wherein the follow-up message represents, in the human-readable text, a successful interaction with the selected SQL database.

10. The method of claim 8 wherein the follow-up message represents, in the human-readable text, an error message provided by the selected SQL database.

11. An apparatus comprising:
a network interface;
a control circuit operably coupled to the network interface and configured to:
receive from a message source via the network interface a database-update message having at least one data object in a data-independent data format comprising human-readable text;
automatically convert the at least one data object into a structured query language (SQL) message;
select at least one of a plurality of candidate SQL databases to provide a selected SQL database; and
transmit the SQL message to the selected SQL database.

12. The apparatus of claim 11 wherein the data-independent data format comprises a JavaScript Object Notation (JSON) format.

13. The apparatus of claim 11 wherein the control circuit comprises a web server.

14. The apparatus of claim 11 wherein the control circuit runs in an Apache Tomcat instance.

15. The apparatus of claim 11 wherein the human-readable text includes information specifying a particular country, a particular store, and a particular date.

16. The apparatus of claim 11 wherein the data-independent data format supports at least one of the following value types: stringValue, intValue, doubleValue, boolValue, and dateValue.

17. The apparatus of claim 11 wherein the data-independent data format only supports insert, update, and select value types.

18. The apparatus of claim 11 wherein the control circuit is further configured to:
subsequent to transmitting the SQL message, transmit to the message source via the network interface a follow-up message comprising human-readable text.

19. The apparatus of claim 18 wherein the follow-up message represents, in the human-readable text, a successful interaction with the selected SQL database.

20. The apparatus of claim 18 wherein the follow-up message represents, in the human-readable text, an error message provided by the selected SQL database.
